(19) United States
(12) Patent Application Publication
(10) Pub. No.: US 2026/0260471 A1
(43) Pub. Date: Sep. 3, 2026

(54) SYSTEMS AND METHODS FOR GENERATING LABELED SYNTHETIC STRUCTURAL STATE TRAINING DATA USING PARAMETERIZED MODELING, CONDITION SYNTHESIS, AND INTRINSIC LABELING

(71) Applicant: Kevin Ramesh Kabaria, Richlands, VA (US)

(72) Inventor: Kevin Ramesh Kabaria, Richlands, VA (US)

(21) Appl. No.: 19/546,430

(22) Filed: Feb. 23, 2026

Related U.S. Application Data
(60) Provisional application No. 63/762,067, filed on Feb. 23, 2025.

(51) Int. Cl. G06V 10/774; G06N 20/00; G06T 7/80

(52) U.S. Cl. CPC G06V 10/774; G06N 20/00; G06T 7/80

(57) ABSTRACT

A computer-implemented system generates labeled synthetic training data for structural state and condition assessment. The system generates a parameterized model of at least one structural component, synthesizes simulated condition state changes by applying perturbation inputs through a state transition function, renders at least one base image under simulated capture conditions, and computes intrinsic ground-truth labels aligned to the rendered view using known camera parameters without human annotation. In some embodiments, the intrinsic labels include a multi-dimensional state tensor encoding structural state. In some embodiments, a composable construction grammar enables bottom-up structural assembly. In some embodiments, rendered images are refined using composable style transfer while preserving semantics. The generated labeled samples are stored for downstream training and evaluation across a range of tasks including damage detection, measurement, material classification, and condition forecasting.

### CROSS-REFERENCE TO RELATED APPLICATIONS

This application claims the benefit of U.S. Provisional Patent Application No. 63/762,067, filed Feb. 23, 2025, entitled “SYSTEMS AND METHODS FOR GENERATING SYNTHETIC PROPERTY DAMAGE DATA USING 3D MODELING AND STYLE TRANSFER,” the entire disclosure of which is incorporated herein by reference.

### FIELD OF THE INVENTION

The present disclosure relates to computer-implemented systems and methods for generating labeled synthetic training data for machine learning models. More particularly, the present disclosure relates to generating synthetic imagery and intrinsic ground-truth labels depicting structural state and/or condition of one or more structural components by combining parameterized modeling, condition synthesis, rendering under simulated capture conditions, and optional image refinement.

### BACKGROUND OF THE INVENTION

Automated inspection and assessment of structures and built-environment assets using computer vision and machine learning can involve detecting damage, estimating severity, segmenting components, classifying materials, measuring geometry, identifying construction defects, and generating structured condition reports.

Conventional approaches rely on real-world imagery and manual labeling. Such datasets are expensive, slow to produce, inconsistent across labelers, and subject to labeler error. Manual labeling typically lacks coverage of rare conditions, rare condition combinations, and rare structural configurations. The combinatorial space of structures, materials, conditions, and capture environments in the built environment far exceeds what any feasible collection of real-world imagery can cover.

Aerial and drone imagery, which represent common capture modalities for structural assessment, present additional challenges. Such imagery inherently provides lower information density than direct physical inspection, and the prior construction and maintenance history of a captured structure is generally unknown. Furthermore, the built environment is characterized by highly varied, human-driven construction practices, custom solutions, and diverse material choices, making it an inherently challenging domain for training robust machine learning models.

Basic two-dimensional augmentation does not reproduce three-dimensional effects associated with physical processes such as hail impacts, wind-driven uplift, and progressive aging. Pure physics-based simulation approaches, while rigorous in principle, can be computationally intractable at the scale needed for training data generation and may require modeling physical mechanisms at a level of detail (e.g., molecular or atomic) that is unnecessary for the purpose of generating training data. Digital twin approaches that reconstruct specific real-world structures do not generalize across the combinatorial space of structural configurations, materials, and conditions needed for robust model training.

Unconstrained domain randomization, in which visual properties are varied without causal structure linking perturbation inputs to their structural effects, can produce visually plausible but physically implausible condition states. Training data generated through unconstrained randomization may fail to encode causal relationships between perturbation inputs and their structural effects. Models trained on such data may learn spurious correlations rather than causal mechanisms, limiting their ability to generalize to real-world conditions and to support tasks requiring causal reasoning, such as condition forecasting or intervention analysis.

Accordingly, there remains a need for scalable systems that generate diverse, labeled training data with reduced label noise, controllable coverage of condition scenarios, causal structure linking perturbation inputs to effects, and support for a broad range of downstream tasks.

### SUMMARY OF THE INVENTION

The present disclosure provides a computer-implemented pipeline that generates labeled synthetic training samples depicting structural state and/or condition of one or more structural components. In one embodiment, the pipeline: (i) generates a parameterized model of at least one structural component; (ii) applies condition synthesis to produce a simulated condition state and a condition state artifact describing one or more condition instances; (iii) renders at least one base image under simulated capture conditions with known camera parameters; (iv) computes intrinsic labels derived from simulator state and aligned to the base image using the camera parameters without human annotation; and (v) stores the labeled synthetic sample in a dataset repository.

In some embodiments, the pipeline optionally refines the base image using style transfer or other learned refinement while preserving semantics. In some embodiments, refinement is composable and may be applied independently at a micro-component level and at a macro-structure level. In some embodiments, an integrity verifier checks label preservation and triggers accept, regenerate, or fallback actions based on task-specific criteria.

In some embodiments, the pipeline uses a composable, parameterized construction grammar to generate structural components bottom-up from primitives or subcomponents with configurable detail. In some embodiments, the pipeline applies a causal mapping from perturbation inputs to parameter changes to produce plausible state transitions, distinguishing the pipeline from unconstrained domain randomization. The perturbation inputs may include environmental stressors, mechanical impacts, human-caused actions, aging effects, repairs, or any other factor that changes structural state.

In some embodiments, the condition state artifact includes a multi-dimensional state tensor encoding structural state at a component or system level. The state tensor may serve as a ground-truth label for downstream machine learning tasks.

Technical improvements enabled by the disclosed systems can include: reduced label noise through intrinsic labels derived from simulator state; controlled coverage of rare conditions and rare condition combinations; improved robustness to capture variation through systematic capture-profile sampling including sensor emulation; reduced privacy risk through generation of training data without using imagery of any specific real-world structure; causal structure linking perturbation inputs to state changes, enabling models to learn causal mechanisms rather than spurious correlations; and scalable generation across the combinatorial space of structural configurations, materials, and conditions.

### BRIEF DESCRIPTION OF THE DRAWINGS

FIG. 1 is a block diagram illustrating an example system architecture for generating labeled synthetic samples.

FIG. 2 is a flowchart illustrating an example method for generating labeled synthetic samples with optional refinement and integrity gating.

FIG. 3 is a block diagram illustrating an example parameterized model generation subsystem, including a construction-grammar embodiment.

FIG. 4 is a block diagram illustrating an example condition/state synthesis subsystem with perturbation inputs and a state transition function.

FIG. 5 is a block diagram illustrating an example rendering pipeline with capture-profile variation, sensor emulation, and optional auxiliary channels.

FIG. 6 is a block diagram illustrating an example intrinsic labeling pipeline that aligns simulator state to a rendered view, including state tensor output.

FIG. 7 is a block diagram illustrating an example composable refinement pipeline with micro-component and macro-structure refinement stages.

FIG. 8 is a block diagram illustrating an example integrity verifier for refinement with task-specific criteria.

FIG. 9 is a block diagram illustrating an example dataset assembly and metadata storage.

FIG. 10 is a block diagram illustrating an example training and evaluation pipeline using synthetic data and optional real data for multiple downstream tasks.

FIG. 11 is a block diagram illustrating an example feedback-driven targeted synthesis loop.

### DETAILED DESCRIPTION OF PREFERRED EMBODIMENTS

### A. Definitions

The term structural component as used herein refers to a modeled element of a structure or built-environment asset. Non-limiting examples include roof regions, siding panels, window regions, gutters, flashings, fasteners, HVAC units, skylights, chimneys, solar panels, bridge elements, road surfaces, paving elements, decks, fences, and landscaping elements.

Structural state refers to a comprehensive description of a structure or component that may include geometry, dimensions, materials, configuration, assembly relationships, and condition. Structural state is broader than condition alone; damage is a subset of condition, and condition is a subset of structural state.

Condition instance refers to a localized defect, degradation, aging effect, missing component, repair, construction defect, or other condition change with at least a type, location, and severity or extent. Non-limiting examples include cracks, dents, missing elements, uplifted seams, delamination, corrosion, biological growth, ponding, sagging, and patches.

Condition state artifact refers to a structured representation of simulated condition/state outputs. The condition state artifact may include per-instance records, masks or maps, severity fields, geometry deltas, and/or state vectors or tensors. In some embodiments, the condition state artifact includes a multi-dimensional state tensor.

State tensor refers to a multi-dimensional array, learned vector representation, or other structured representation encoding structural state at a component or system level. State tensors may be composable: component-level state tensors may be composed into system-level state tensors. The state tensor may itself serve as a ground-truth label for downstream tasks.

Condition tensor refers to a task-dependent abstraction derived from the state tensor by extracting or projecting the subset of state tensor dimensions relevant to a specific downstream task or business objective. The condition tensor is distinct from the state tensor: the state tensor encodes the full physical and functional state of a component, whereas the condition tensor represents a task-relevant subset or transformation thereof. Multiple condition tensors may be derived from a single state tensor to support multiple concurrent downstream tasks.

Stressor vector refers to a structured representation encoding one or more perturbation inputs that drive state transitions. The stressor vector is not limited to a specific dimensionality, structure, or content; it may be a flat vector, a hierarchical structure, a graph, or any other structured encoding of perturbation inputs. The stressor vector may encode any factor that changes structural state, including, without limitation, environmental exposure, mechanical impacts, biological growth, chemical exposure, human-caused events, and other factors.

The term intrinsic label as used herein refers to a ground-truth label derived from simulator state rather than human annotation. Intrinsic labels may include spatial annotations (masks, polygons, bounding regions), non-spatial outputs (scalar values, categorical labels, severity values), and/or richer representations such as multi-dimensional state tensors or state vectors.

The term perturbation input as used herein refers to any input to a state transition function that causes a change from one structural state to another. Perturbation inputs are not limited to environmental factors and may include, without limitation, weather events (hail, wind, UV radiation, temperature cycling, precipitation), mechanical impacts (kinetic forces from objects), human-caused actions (foot traffic, accidental damage), aging processes, construction defects, repair actions, material replacements, and any other factor that changes structural state.

State transition function refers to a function that maps perturbation inputs and a current parameterized state to a next parameterized state. The state transition function may be rule-based, learned, or a hybrid of rule-based and learned components. Perturbation-to-parameter mappings may be one-to-one, one-to-many, many-to-one, or many-to-many.

Construction grammar refers to a composable, parameterized mechanism for assembling structural components from primitives or subcomponents according to configurable assembly rules. The construction grammar is not limited to a specific file format, rendering engine, or software tool. In some embodiments, the construction grammar is hierarchical; in some embodiments, the construction grammar uses a flat representation with explicit parameters.

Parameterized model refers to a digital representation of one or more structural components in which the representation is defined by a set of configurable parameters including at least geometry parameters and material parameters. The parameterized model is not limited to a specific dimensionality (e.g., two-dimensional, three-dimensional, or time-varying) or to a specific rendering engine.

The term causal mapping as used herein refers to a deterministic or learned mapping from one or more perturbation inputs to one or more parameter changes in a parameterized model or condition state artifact, such that each parameter change is attributable to a specific perturbation input or combination of perturbation inputs. Causal mapping is distinguished from unconstrained domain randomization, in which parameter values are varied without structured linkage to perturbation inputs.

Capture profile refers to a set of simulated capture conditions such as viewpoint, camera parameters (including focal length, altitude, distance, and angle), lighting conditions, atmospheric effects, and sensor artifacts. Sensor artifacts may include lens blur, motion blur, distortion, compression artifacts, and sensor noise. As used herein, a camera model refers to the mathematical representation of a camera's projection characteristics, including intrinsic parameters (such as focal length, principal point, and lens distortion coefficients) and extrinsic parameters (such as position and orientation relative to the scene). The camera model is a component of the capture profile; the capture profile additionally encompasses environmental and sensor conditions beyond the camera model itself.

Refinement refers to a transformation that maps a base render toward a target appearance distribution while preserving semantics. Refinement may include style transfer using generative models and/or other learned or deterministic transformations. In some embodiments, refinement is composable, with independent refinement stages applied at a micro-component level and a macro-structure level.

### B. System Overview

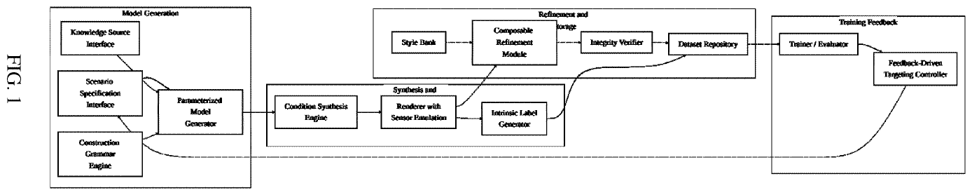

Referring to FIG. 1, a system includes one or more processors and one or more memories storing instructions for generating labeled synthetic training samples. In one embodiment, the system includes: a scenario specification interface; a parameterized model generator; a condition synthesis engine; a renderer with sensor emulation; an intrinsic label generator; and a dataset repository. Optional modules include: a construction grammar engine; a knowledge source interface; a style bank; a composable refinement module; an integrity verifier; a trainer/evaluator; and a feedback-driven targeting controller.

The system may execute on local hardware, cloud-based computing resources, GPU-accelerated systems, CPU-based systems, distributed computing clusters, or any combination thereof.

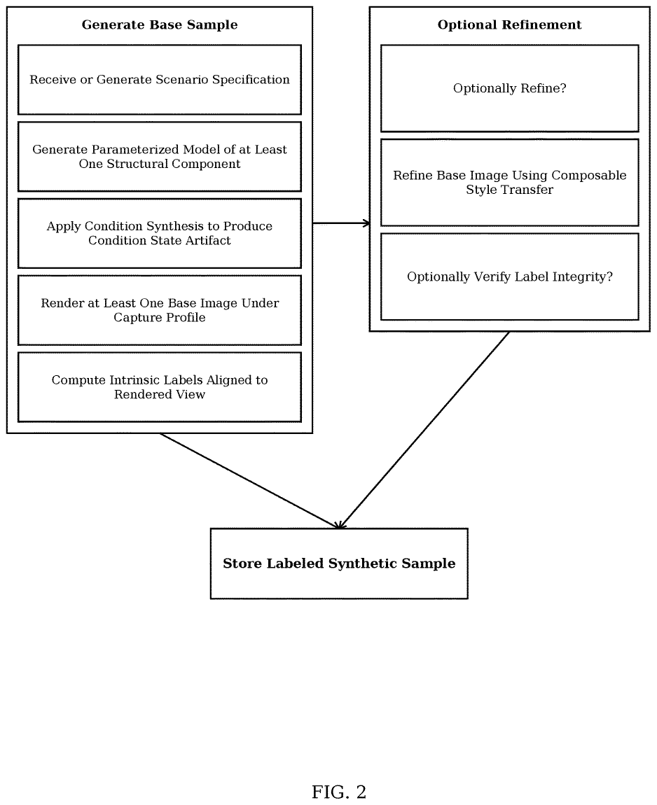

Referring to FIG. 2, an example method for generating labeled synthetic samples includes: receiving or generating a scenario specification; generating a parameterized model of at least one structural component; applying condition synthesis to produce a condition state artifact; rendering at least one base image under a capture profile; computing intrinsic labels aligned to the rendered view; optionally refining the base image using composable style transfer; optionally verifying label integrity; and storing the labeled synthetic sample. Steps of the method may be performed in different orders, repeated, or omitted depending on the embodiment.

In some embodiments, the system is not limited to three-dimensional representations. The parameterized model may be two-dimensional, three-dimensional, four-dimensional (incorporating temporal state transitions as an additional dimension), or of higher dimensionality as appropriate for the structural domain and downstream task objective. One skilled in the art will recognize that the choice of dimensionality is an embodiment choice that may be selected based on the requirements of the downstream tasks, the available computational resources, and the nature of the structural domain being modeled.

In certain embodiments, the system generates two-dimensional parameterized models for downstream tasks in which plan-view analysis is sufficient, such as roof area measurement, component segmentation from overhead imagery, site-level layout analysis, and other plan-view tasks known to those skilled in the art. In such embodiments, the construction grammar and condition synthesis operate on a two-dimensional representation, and the renderer produces two-dimensional output images directly. In other embodiments, the system generates four-dimensional representations that incorporate temporal state transitions, enabling generation of time-series training data depicting progressive structural change.

### C. Parameterized Model Generation

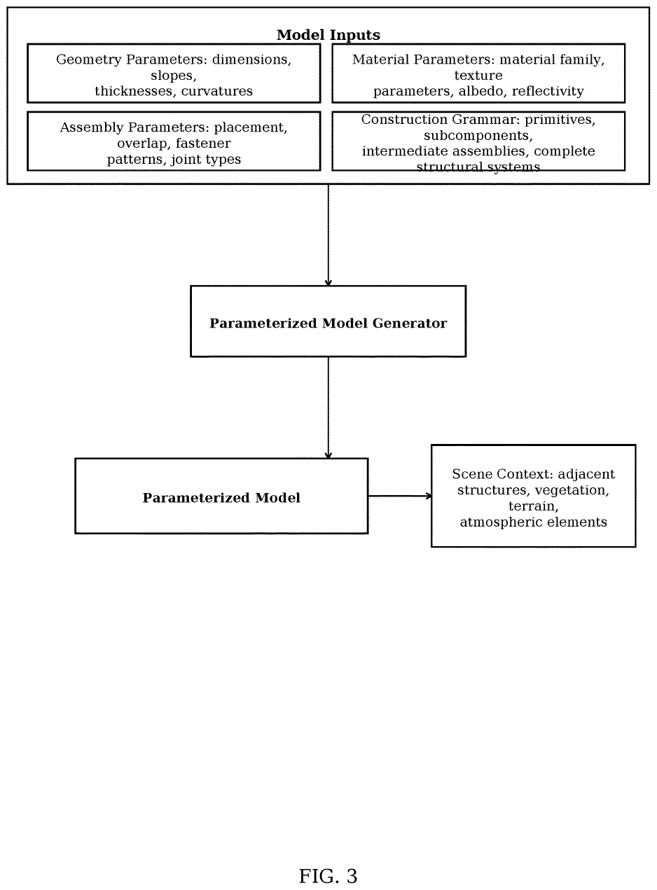

Referring to FIG. 3, the parameterized model generator produces a parameterized model of at least one structural component. Parameters may include geometry parameters (e.g., dimensions, slopes, thicknesses, curvatures), material parameters (e.g., material family, texture parameters, albedo, reflectivity, porosity), and assembly parameters (e.g., placement, overlap, fastener patterns, joint types).

In some embodiments, the parameterized model generator is implemented using a composable, parameterized construction grammar that assembles subcomponents into larger components according to configurable assembly rules. The construction grammar enables bottom-up construction of structures from granular primitives (e.g., individual granules on a shingle surface, individual fasteners, individual shingles) through intermediate assemblies (e.g., shingle courses, flashing systems, ridge cap assemblies) to complete structural systems (e.g., a complete roofing system, a building envelope). The level of detail is configurable; the grammar may be invoked at any level of the hierarchy depending on the task objective.

In some embodiments, the construction grammar is hierarchical, with parent-child relationships between components. In some embodiments, the construction grammar uses a flat representation with explicit parameters and no hierarchical nesting. The choice between hierarchical and flat representations is an embodiment choice.

In some embodiments, the parameterized model includes scene context such as adjacent structures, vegetation, terrain, and atmospheric elements. Scene context may improve the realism of rendered samples and provide occlusion training opportunities.

In some embodiments, the model representation is three-dimensional. In certain embodiments, the model representation is two-dimensional. In certain embodiments, the model representation includes a time dimension (e.g., a sequence of states). The parameterized model is not limited to a specific dimensionality.

In some embodiments, knowledge for constructing grammars and defining parameters is sourced from one or more of: domain experts, large language models, external databases, material specifications, manufacturer specifications, warranty documents, building codes, lab testing data, actuarial data, weather data, and automated knowledge extraction systems.

In some embodiments, the parameterized model generator can produce structures that do not exist in the real world, including topologically complex geometries, unusual material combinations, or extreme dimensional ranges, when such structures serve the training objective (e.g., improving measurement robustness or stress-testing a classifier). It will be appreciated by those skilled in the art that the parameterized model generator is not limited to reproducing existing structures or configurations, and that the ability to generate structures beyond those found in the real world is one of several advantages of the disclosed systems for producing diverse training data.

In some embodiments, the construction grammar defines a multi-level component hierarchy in which primitive elements compose into subcomponents, subcomponents compose into intermediate assemblies, and intermediate assemblies compose into complete structural systems. Using roofing as one non-limiting example domain, the hierarchy may include levels such as individual granules composing onto a shingle surface, individual shingles assembling into shingle courses, shingle courses combining with flashing systems and ridge cap assemblies to form a roofing plane, and roofing planes integrating with penetrations, valleys, hips, and other elements to form a complete roofing system. Those skilled in the art will appreciate that other structural domains use analogous hierarchies with domain-appropriate primitives and assemblies, and that the specific hierarchy described here is illustrative and not limiting in any manner.

For example, in one embodiment applied to a roofing domain, each level of the construction grammar hierarchy maintains independent configurable parameters. Non-limiting examples of parameters at various hierarchy levels include: at a granule or surface-texture level, parameters such as reflectivity, color, adhesion to substrate, and granule density; at a shingle or panel level, parameters such as material family, dimensions, thickness, profile shape, and surface treatment; at a course or section level, parameters such as alignment offset, overlap dimension, fastener pattern, and seam characteristics; and at a system level, parameters such as pitch angle, valley count, ridge configuration, eave depth, and overall footprint geometry, and other parameters relevant to the structural domain. The number and type of parameters at each level is configurable and may vary by component type, material family, and task objective.

In some embodiments, the parameterized model generator accesses a material library comprising parameterized material definitions. Non-limiting examples of material families include asphalt shingle types (such as, without limitation, three-tab, architectural, and designer profiles), single-ply membranes (such as, without limitation, thermoplastic polyolefin, ethylene propylene diene monomer, and modified bitumen), metal roofing materials, natural materials (such as, without limitation, cedar shakes, slate, and terracotta), concrete and clay tiles, vinyl and fiber cement siding materials, coatings of various compositions, and other materials known to those skilled in the art. Each material definition may include baseline physical properties such as initial UV degradation coefficient, base adhesion strength, thermal expansion coefficient, albedo, reflectivity, porosity, and other material-specific parameters.

In one embodiment, the construction grammar produces a combinatorial space of structural configurations by varying assembly parameters across defined ranges. Non-limiting examples of assembly parameters include overlap dimensions, fastener spacing, joint types, placement offsets, layering configurations (single-layer, double-layer), slope variations, curvature parameters, and other assembly parameters relevant to the structural component type. It will be appreciated by those skilled in the art that the composable nature of the construction grammar enables exponential growth in the number of unique structural configurations as additional component types and parameter ranges are defined, without requiring each configuration to be individually specified.

In some embodiments, the construction grammar supports a reversal operation in which a parameterized specification is reconstructed from an existing model or from inspection data. In such embodiments, a transformation layer maps observed structural characteristics (such as geometry, material, and configuration) back to construction grammar parameters, enabling bidirectional use of the grammar: a forward direction from parameters to structural model, and a reverse direction from observed structure to parameters. This bidirectional capability supports downstream applications including, without limitation, specification reconstruction, as-built documentation, and comparative analysis between designed and observed configurations.

In further embodiments, the construction grammar extends to non-structural elements that form part of the scene context for rendering. Non-limiting examples of scene context elements include trees and vegetation (which may create occlusion in rendered views), HVAC units, solar panel arrays, satellite dishes, chimneys, adjacent structures, driveways, fences, landscaping features, and other scene elements. Scene context elements may be generated using the same parameterized grammar mechanism or using separate generation techniques. The inclusion of scene context elements improves the realism of rendered training samples and provides occlusion training opportunities for downstream models, enabling those models to learn to reason about partially occluded structural components.

In some embodiments, the construction grammar incorporates construction defects as parameterized variations in the initial structural state. Construction defects represent deviations from design specifications that are introduced during the construction or assembly process, rather than through subsequent degradation or environmental exposure. The system distinguishes construction defects from condition changes caused by perturbation inputs: construction defects are encoded in the initial state of the parameterized model (the state at the time of construction), whereas degradation and damage are produced through subsequent application of perturbation inputs via the state transition function.

Non-limiting examples of construction defects that may be modeled via the construction grammar include missing components (such as missing shingles, missing fasteners, or missing flashing segments), incorrectly installed components (such as shingles installed with incorrect exposure, fasteners placed outside manufacturer-specified zones, or flashing installed with insufficient overlap), off-specification assembly (such as incorrect nail patterns, inadequate adhesive application, or non-code-compliant configurations), and other deviations from design specifications known to those skilled in the art. In one embodiment, the construction grammar parameterizes each defect type with a probability of occurrence and a severity distribution, enabling controlled generation of defective configurations.

In some embodiments, the system identifies construction defects in training data precisely because the defects were constructed as part of the grammar. Because the construction grammar explicitly encodes whether a component is present, correctly positioned, and properly assembled, the intrinsic labels for construction defects are derived directly from the grammar specification without additional annotation. This grammar-based defect identification enables training of downstream models to detect construction defects from imagery with ground-truth labels that are intrinsically correct.

In some embodiments, the composable nature of the construction grammar reduces per-component data requirements relative to approaches that model complete structures monolithically. Because variations at each hierarchy level are defined independently and composed according to assembly rules, the total number of unique structural configurations grows combinatorially with the number of component types and parameter values, while the data required to define each component type grows only linearly. In some embodiments, learning state transitions at the component level enables composition into system-level behaviors without requiring system-level training data for every possible configuration, thereby reducing the data requirements for achieving comprehensive coverage of the structural configuration space.

In some embodiments, the parameterized model generator incorporates a reproducibility seed that controls stochastic variation in assembly and perturbation sampling. The reproducibility seed enables deterministic regeneration of a specific structural configuration, including any stochastic elements such as random granule placement, chaotic assembly offsets, probabilistic defect introduction, and other sources of stochastic variation. In certain embodiments, the reproducibility seed is stored as part of the sample metadata, enabling exact reproduction of any generated sample for auditing, debugging, or controlled experimentation purposes.

### D. Condition/State Synthesis

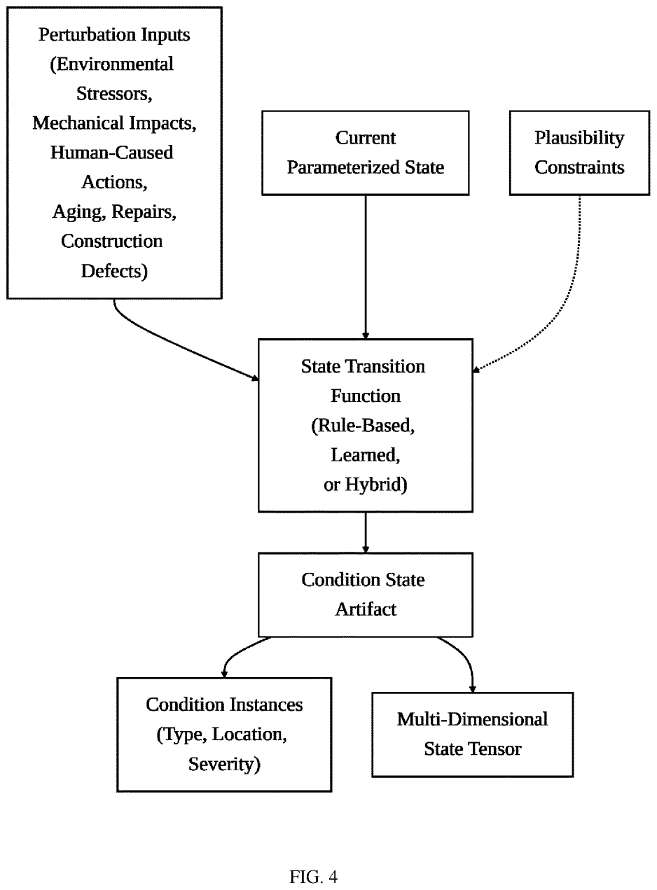

Referring to FIG. 4, the condition synthesis engine generates a simulated condition state by applying one or more condition synthesis operations to the parameterized model. Non-limiting examples of condition synthesis operations include hail impact, wind-driven uplift, UV/aging effects, missing components, cracking, delamination, corrosion, biological growth (moss, algae), ponding, erosion, mechanical impacts, construction defects (missing fasteners, mispositioned components, incorrect installations), and repairs or patches.

In some embodiments, condition synthesis is event-based: a single perturbation event is applied. In some embodiments, condition synthesis is time-evolving: a sequence of perturbation inputs is applied over simulated time steps to model progressive degradation, periodic maintenance, or event-driven changes. In some embodiments, the system receives or samples perturbation inputs and applies a state transition function to map perturbation inputs and the current parameterized state to parameter changes.

The perturbation inputs are not limited to environmental or weather-related factors. In some embodiments, perturbation inputs include mechanical impacts (e.g., kinetic forces from falling objects, vehicle collisions), human-caused actions (e.g., foot traffic damage, accidental impacts), construction defects introduced during initial assembly, repair actions that improve the structural state, material replacements, and any other factor that changes structural state.

In some embodiments, the condition synthesis engine receives a stressor vector encoding one or more perturbation inputs that drive state transitions. The stressor vector is not limited to a specific dimensionality or structure; it may be a flat vector, a hierarchical structure, a graph, or any other structured representation of perturbation inputs. The stressor vector is not limited to environmental or weather-related factors and may encode any factor that changes structural state, including, without limitation, environmental exposure (UV radiation, moisture, temperature cycling, precipitation), mechanical impacts (kinetic forces from hail, falling objects, vehicle collisions, foot traffic), biological growth (moss, algae, mold, root intrusion), chemical exposure (acid rain, industrial pollutants, salt spray), acts of nature (earthquakes, floods, fire, ice), human-caused events (vandalism, accidental damage, construction activity), and other factors known to those skilled in the art.

For example, in one embodiment, the stressor vector includes dimensions representing non-weather perturbation inputs such as mechanical impacts from falling debris or vehicle contact, construction-phase actions such as foot traffic on a newly installed surface, biological colonization rates for organisms such as moss and algae, chemical exposure from atmospheric pollutants or cleaning agents, human-caused events such as accidental damage or intentional modification, and other perturbation types relevant to the structural domain. Each dimension of the stressor vector may be sampled independently or jointly from configurable probability distributions, and the stressor vector may vary by component type such that different components respond to different subsets of the stressor space.

In some embodiments, the state transition function supports one-to-many mappings in which a single perturbation input produces changes across multiple state tensor dimensions simultaneously. For example, in one non-limiting embodiment, a hail impact of a given kinetic energy may simultaneously reduce granulation coverage, introduce crack density, weaken adhesion strength, create localized displacement, and produce other structural effects, with the magnitude of each effect determined by the perturbation magnitude and the current state of the affected component. The one-to-many mapping captures the physical reality that a single perturbation event may have multiple simultaneous structural consequences.

In some embodiments, the state transition function supports many-to-one mappings in which multiple perturbation inputs jointly determine a single parameter change. For example, in one non-limiting embodiment, UV-induced embrittlement (which weakens the material over time) and a wind gust (which applies mechanical force) may jointly cause shingle uplift that neither perturbation alone would produce at the same magnitude. The many-to-one mapping captures the physical reality that structural failures often result from the interaction of multiple concurrent or sequential stressors rather than from any single stressor acting in isolation.

In some embodiments, perturbation magnitudes are sampled from configurable probability distributions that may extend beyond real-world observed ranges to improve model robustness. Non-limiting examples of suitable distributions include Gumbel distributions for modeling extreme value events such as maximum hail size or peak wind speed, Weibull distributions for modeling time-to-failure or degradation rate, log-normal distributions for modeling material property variation, and other probability distributions known to those skilled in the art. In some embodiments, the distributions are parameterized by geographic region, climate zone, historical weather data, or other contextual factors. In certain embodiments, the system intentionally samples from distribution tails or beyond observed distribution ranges to generate training data for extreme or unprecedented conditions, thereby improving the robustness of downstream models to out-of-distribution events.

In some embodiments, the state transition function is rule-based (e.g., derived from domain knowledge, lab studies, material specifications, or actuarial data). In some embodiments, the state transition function is learned (e.g., trained from observational data, lab data, or simulated data using neural networks, graph neural networks, or other learned function approximators). In some embodiments, the state transition function is a hybrid combining rule-based and learned components.

In some embodiments, the state transition function supports one-to-many mappings, in which a single perturbation input produces changes across multiple parameters or components. In some embodiments, the state transition function supports many-to-one mappings, in which multiple perturbation inputs jointly determine a single parameter change. In some embodiments, the state transition function supports many-to-many mappings.

In some embodiments, the state transition function operates at a component level: each component type has its own state transition behavior. Component-level state transitions may be learned independently and then composed to produce system-level state changes.

The condition synthesis engine outputs a condition state artifact describing one or more condition instances. In some embodiments, the condition state artifact includes a multi-dimensional state tensor encoding structural state at the component level and/or the system level. State tensors may be composable: component-level state tensors may be aggregated, concatenated, or otherwise composed into system-level state tensors. The composition may be hierarchical, graph-structured, or flat.

In some embodiments, each component in the parameterized model maintains a multi-dimensional state tensor encoding a plurality of condition-relevant parameters. Non-limiting examples of state tensor dimensions include granulation coverage, embrittlement factor, adhesion parameter, color shift, moisture content, thermal fatigue cycle count, crack density, seam integrity, biological growth coverage, displacement magnitude, and other parameters as appropriate for the structural component type. The number of dimensions in the state tensor is configurable and may vary by component type; the system does not require a fixed dimensionality. In some embodiments, the state tensor encodes the complete physical and functional state of the component, from which condition assessments, severity values, and other downstream labels may be derived as projections or functions of the state tensor.

In some embodiments, component-level state tensors are composed into system-level representations using one or more composition strategies. Non-limiting examples of composition strategies include matrix concatenation, weighted aggregation, graph-based composition (in which components are nodes and physical connections are edges), learned composition using neural network architectures such as graph neural networks or set functions, and hierarchical nesting in which higher-level state tensors are computed as functions of their constituent component-level tensors, and other composition strategies known to those skilled in the art. The choice of composition strategy is an embodiment choice that may depend on the downstream task and the structural domain.

In some embodiments, severity is computed as a function of the state tensor rather than being independently specified. A severity value for a given component may be computed as a projection, aggregation, or other function of one or more dimensions of that component's state tensor. Similarly, a system-level severity value may be computed as a function of the composed system-level state tensor. Because severity is derived from the state tensor, severity labels are guaranteed to be consistent with the underlying simulated state. In some embodiments, the mapping from state tensor to severity is task-specific: the same state tensor may yield different severity assessments depending on the downstream task objective, the applicable standards, or the use context.

In some embodiments, the dimensionality of the state tensor is configurable and may vary by component type, material family, or task objective. In some embodiments, the state tensor has a relatively small number of dimensions for computational efficiency in large-scale generation. In other embodiments, the state tensor has a larger number of dimensions for higher-fidelity state representation. In certain embodiments, the state tensor uses a learned representation such as a latent vector produced by an autoencoder or variational autoencoder, in which case the dimensionality is determined by the architecture of the learned model rather than by manual specification. One skilled in the art will recognize that the specific dimensionality of the state tensor is an implementation choice and does not limit the scope of the disclosed systems.

In some embodiments, the system distinguishes between a state tensor encoding the full physical and functional state of each component, and a condition tensor representing a task-dependent abstraction derived from the state tensor. The state tensor is the ground-truth representation and encodes all parameters relevant to the structural state, including geometry, material properties, degradation parameters, and functional characteristics. The condition tensor is a derived representation that extracts or projects the subset of state tensor dimensions relevant to a specific task or business objective. In this manner, the same state tensor may yield different condition assessments depending on the task context, without requiring regeneration of the underlying structural model or its associated state.

For example, in one non-limiting embodiment, a slight crack in a structural component may represent a critical condition for an aircraft fuselage component but may be an irrelevant cosmetic characteristic for a garden fence component. Similarly, water permeability may be a critical condition dimension for a roofing system in a high-precipitation climate but may be irrelevant for a roofing system in an arid environment where the task objective is solar panel mounting assessment. The condition tensor allows downstream models to be trained on task-relevant condition representations without requiring the state tensor to be redefined for each task. In some embodiments, multiple condition tensors may be derived from a single state tensor to support multiple concurrent downstream tasks.

In some embodiments, the system enforces plausibility constraints that restrict or shape the output space based on a task objective. Plausibility constraints may forbid physically implausible combinations (e.g., certain material and perturbation combinations that cannot co-occur in the physical world). In some embodiments, plausibility constraints are relaxed to permit states that are unusual or do not commonly occur in the real world when such states serve the training objective (e.g., generating rare edge cases for robustness).

In some embodiments, condition synthesis includes repair modeling: a state transition may produce an improved state (e.g., a patch, a coating application, a component replacement) rather than a degraded state. Repair modeling enables training data for tasks such as repair detection and intervention analysis.

In some embodiments, the state transition function models degradation cascades in which a first perturbation alters a first parameter of the state tensor, which in turn affects one or more downstream parameters in subsequent transition steps. The cascade mechanism captures the physical reality that structural degradation is often a multi-step process in which initial perturbation effects propagate through the structural system, with each step potentially enabling or accelerating subsequent degradation modes.

For example, in one non-limiting embodiment, a UV degradation cascade proceeds as follows: sustained UV exposure increases an embrittlement factor in the state tensor, which over subsequent transition steps reduces granulation coverage as embrittled granules are shed, which in turn decreases the adhesion parameter as the protective surface layer is lost, which increases vulnerability to wind-driven uplift in subsequent wind perturbation events. Each step in the cascade is governed by the state transition function, and the cascade unfolds over multiple simulated time steps in a manner consistent with the causal relationships encoded in the transition rules or learned transition model.

In a further embodiment, the state transition function models interactions between concurrent perturbation types. For example, in one non-limiting embodiment, thermal cycling (which causes expansion and contraction of materials) combined with moisture infiltration (which freezes in cold conditions) produces accelerated cracking that neither thermal cycling nor moisture infiltration alone would produce at the same rate. The interaction between perturbation types is captured in the state transition function through multi-input transition rules or learned interaction terms, enabling generation of training data that reflects the complex, multi-factor nature of real-world structural degradation.

In some embodiments, perturbation magnitudes applied by the state transition function are sampled from statistical distributions. The choice of distribution is configurable and may be selected based on the perturbation type, geographic context, or task objective. Non-limiting examples include Gumbel distributions for extreme-value event modeling, Weibull distributions for time-dependent degradation modeling, and uniform distributions for systematic parameter sweeps, among other distributions known to those skilled in the art. In some embodiments, the distributions are parameterized by real-world data sources such as historical weather records, actuarial data, or laboratory testing results. The distributions are extensible, and additional distribution types may be defined without modifying the core system architecture.

In some embodiments, each component type maintains an independent state transition function. The component-level state transition functions may be developed, calibrated, and validated independently, and then composed to produce system-level state transitions. In some embodiments, the composition of component-level transitions accounts for inter-component dependencies: the state transition of one component may depend on the current state of an adjacent or connected component. In certain embodiments, the inter-component dependencies are modeled using graph-structured representations in which components are nodes and physical connections or adjacency relationships are edges.

In some embodiments, the state transition function is learned from empirical data. Non-limiting examples of learned transition function architectures include graph neural networks (in which structural components are represented as nodes and physical connections as edges, and state transitions are computed via message-passing between connected nodes), conditional diffusion models (which learn to interpolate between states conditioned on perturbation inputs), recurrent neural networks (which model sequential state transitions over time), and other learned function approximators known to those skilled in the art. In another embodiment, the state transition function comprises a hybrid architecture combining rule-based components for well-understood physical relationships with learned components for relationships that are difficult to specify analytically.

Non-limiting examples of data sources for calibrating or training the state transition function include actuarial tables documenting failure rates and degradation timelines, laboratory testing data from controlled weathering and impact studies, manufacturer specification sheets documenting material performance characteristics, warranty claim data documenting real-world failure patterns, field observation data from inspection programs, historical weather records documenting perturbation event frequencies and magnitudes, and other empirical data sources known to those skilled in the art. In some embodiments, the data sources are used to calibrate rule-based transition functions; in other embodiments, the data sources are used as training data for learned transition functions.

In some embodiments, plausibility constraints applied by the condition synthesis engine are defined relative to the task objective rather than relative to real-world likelihood. In certain embodiments, the system generates structural configurations or condition states that are unusual, rare, or do not commonly occur in the real world, when such configurations serve the training objective. For example, in one embodiment, a topologically complex roof geometry that would not typically be constructed in practice is generated to train a geometry measurement model to handle challenging measurement scenarios. In another embodiment, a structure is generated with intentionally extreme degradation to provide negative examples or stress-test a classification model. The plausibility constraints are configurable and may be relaxed, tightened, or redefined for each generation task.

In some embodiments, the state tensor encodes functional properties of the structural component in addition to visual and geometric properties. Non-limiting examples of functional properties include water-tightness, air permeability, insulation value (such as an R-factor or equivalent thermal resistance metric), structural load capacity, fire resistance, acoustic transmission characteristics, and other functional characteristics known to those skilled in the art. In some embodiments, functional properties are computed from the state tensor using rules or heuristics applied to the simulated state. For example, in one non-limiting embodiment, a water-tightness assessment is derived from the state tensor by evaluating whether any combination of seam integrity, flashing condition, and membrane continuity parameters falls below a task-specific threshold. Functional properties may serve as intrinsic labels for downstream models that predict structural performance from imagery.

In some embodiments, the condition synthesis engine enforces ordering and co-occurrence constraints on perturbation sequences to maintain causal consistency. For example, in one non-limiting embodiment, certain condition combinations are constrained by temporal ordering: ponding (standing water) may be required to precede moisture-related degradation, and UV embrittlement may be required to precede wind-driven shingle uplift that depends on reduced material flexibility. In some embodiments, certain condition combinations that are physically implausible are explicitly excluded from the generation space. In other embodiments, physically implausible combinations are included at a reduced sampling rate to serve as negative training examples. The constraint rules are configurable and may be defined using domain knowledge, empirical data, or learned relationships.

### E. Rendering Under Capture Profiles With Sensor Emulation

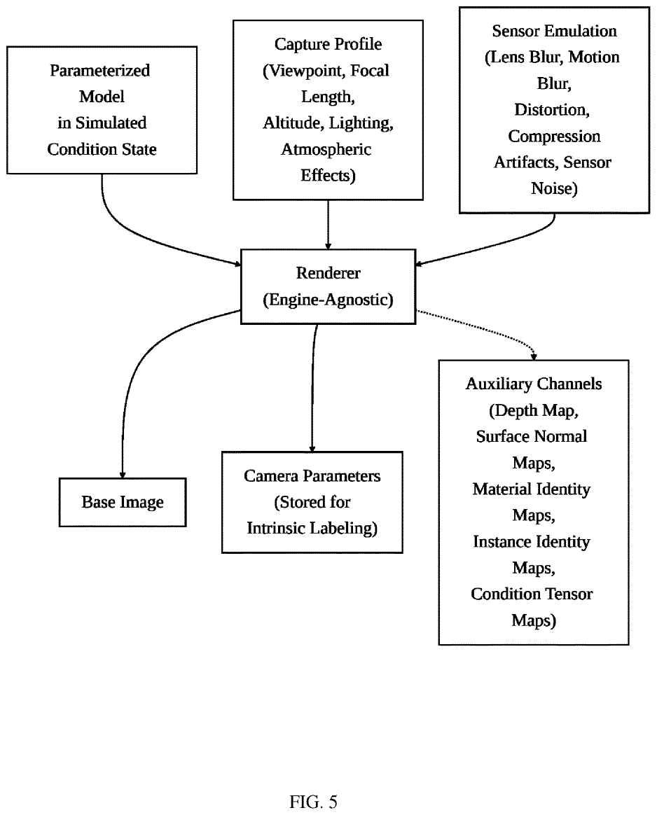

Referring to FIG. 5, the renderer renders at least one base image of the simulated condition state under a capture profile. The system stores camera parameters associated with the rendered view to support intrinsic labeling.

In some embodiments, the renderer varies capture profiles across a distribution to generate diversity in the training data. Non-limiting variations include camera viewpoint (angle, elevation, azimuth), focal length, altitude or range, lighting conditions (sun position, intensity, cloud cover, atmospheric haze, shadows), weather conditions (rain, snow, fog), and sensor artifacts such as lens blur, motion blur, distortion, compression artifacts, sensor noise, and chromatic aberration.

In some embodiments, the renderer emulates characteristics of specific real-world sensors, including focal length ranges, altitude ranges, ground sampling distances, and artifact profiles associated with satellite, aerial, drone, or ground-level capture platforms. In some embodiments, the renderer emulates hypothetical sensor characteristics to support robustness to future or novel capture platforms.

In some embodiments, the renderer also produces auxiliary channels such as depth maps, surface normal maps, material identity maps, instance identity maps, and condition tensor maps. Auxiliary channels may be used as conditioning guides for refinement and/or as additional label channels.

In some embodiments, the renderer produces images at multiple resolutions. Multi-resolution rendering supports training models that operate at varying capture distances and resolutions. In some embodiments, high-resolution renders are downsampled to produce matched low-resolution training pairs with preserved labels.

The renderer is engine-agnostic. In some embodiments, the renderer uses physically-based rendering. In some embodiments, the renderer uses neural rendering or learned image synthesis. In some embodiments, the renderer uses a oneshot configuration-to-image pipeline that maps construction grammar parameters directly to a rendered image without explicit 3D geometry. In some embodiments, the renderer uses a combination of physically-based and learned rendering techniques. Non-limiting rendering tools include ray tracing engines, rasterization engines, real-time rendering engines, neural radiance field renderers, and diffusion-based image generators.

The renderer may execute on GPU-accelerated hardware, CPU hardware, or distributed computing resources. Rendering may be performed in batch, on-demand, or in real-time depending on the application. In certain embodiments, the renderer produces imagery at resolutions and fidelity levels selected to match or exceed the characteristics of imagery captured by real-world sensor platforms deployed in the target domain.

In some embodiments, the sensor emulation module models the characteristics of specific categories of real-world sensor platforms to generate training data that matches the capture conditions encountered in deployment. Non-limiting examples of sensor platforms include aerial survey cameras (such as high-altitude fixed-wing capture systems), unmanned aerial vehicle cameras (such as drone-mounted cameras operating at varying altitudes and speeds), satellite imaging systems (such as multi-spectral and panchromatic satellite sensors), ground-level handheld cameras, vehicle-mounted cameras, and other imaging modalities known to those skilled in the art. For each sensor platform category, the emulation module may model characteristic focal length ranges, altitude ranges, ground sampling distances, capture speeds, and artifact profiles. In some embodiments, the emulation module also models hypothetical sensor configurations that do not correspond to any existing sensor platform, enabling pre-training for future or novel capture technologies.

In some embodiments, the sensor emulation module introduces one or more imaging artifacts that replicate characteristics of real-world image capture. Non-limiting examples of imaging artifacts include lens blur (including spatially-varying blur across the field of view), motion blur (associated with relative motion between sensor and subject), compression artifacts (associated with lossy image encoding), chromatic aberration, barrel distortion and pincushion distortion, atmospheric haze and scattering effects, sensor noise (including shot noise, read noise, and fixed-pattern noise), surface wetness and specular reflection, shadow patterns from solar geometry, and other artifacts known to those skilled in the art. In some embodiments, artifact parameters are sampled from distributions matched to the artifact profiles of target sensor platforms. In certain embodiments, artifact parameters are varied beyond the ranges of any specific sensor platform to improve the robustness of downstream models to novel or degraded capture conditions.

In some embodiments, the renderer incorporates scene context elements into the rendered view, including adjacent structures, vegetation, terrain features, atmospheric conditions, and other environmental elements. The scene context elements may create partial occlusions, cast shadows, contribute reflections, or otherwise affect the appearance of the structural components of interest in the rendered view. In some embodiments, the scene context is generated using the same parameterized construction grammar as the structural components; in other embodiments, the scene context is generated using separate generation techniques or sourced from pre-existing asset libraries. The inclusion of scene context in rendered training samples enables downstream models to learn to reason about structural components in the presence of occlusions, shadows, and environmental context.

In some embodiments, the renderer uses a neural rendering pipeline that maps construction grammar parameters or state tensor values directly to rendered images without generating explicit three-dimensional geometry as an intermediate representation. In one embodiment, a conditional generative model receives the parameterized state as input and produces a rendered image conditioned on the capture profile parameters. In another embodiment, the renderer combines a traditional physically-based rendering stage with a neural refinement stage, in which a neural network refines the traditionally rendered image to improve photorealism while preserving the geometric and label correspondence established by the traditional renderer. One skilled in the art will recognize that the choice of rendering technique is an implementation detail and that the disclosed systems are agnostic to whether rendering is performed using traditional, neural, or hybrid approaches.

In some embodiments, the renderer produces multi-modal output imagery spanning multiple sensing modalities. Non-limiting examples of sensing modalities include visible-spectrum (RGB) imagery, thermal (infrared) imagery, hyperspectral imagery, LiDAR-derived point clouds or depth maps, synthetic aperture radar imagery, and other sensing modalities known to those skilled in the art. In some embodiments, all modalities are generated from the same underlying parameterized model and state tensor, ensuring that labels and state representations are co-registered and causally consistent across modalities. Multi-modal training data enables training of downstream models that fuse information from multiple sensing modalities, or that transfer knowledge learned from one modality to another.

### F. Intrinsic Labeling

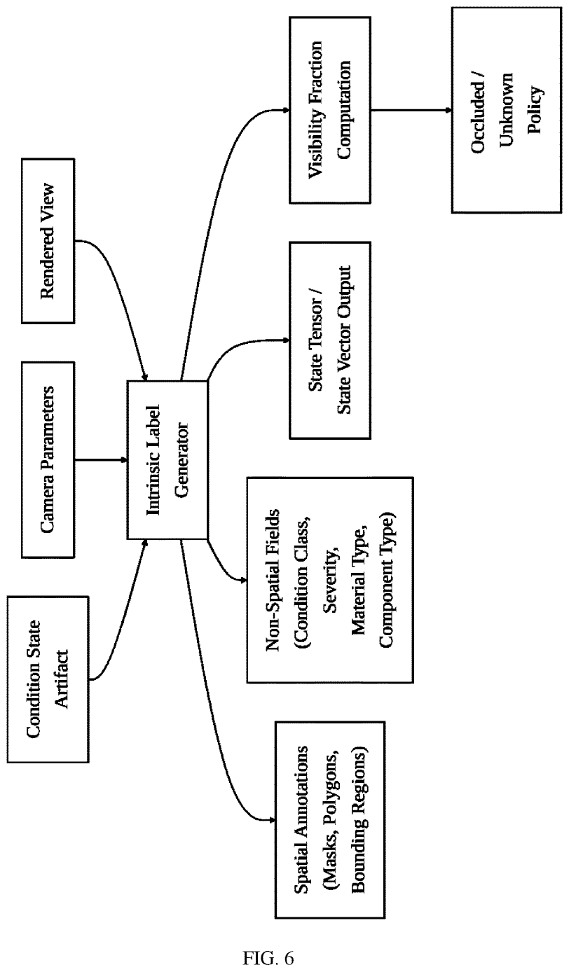

Referring to FIG. 6, the intrinsic label generator computes intrinsic labels derived from simulator state and aligned to the rendered view using known camera parameters.

In one embodiment, the intrinsic label generator projects condition instances from the condition state artifact into image space to produce spatial annotations, such as masks, polygons, and/or bounding regions, for each visible condition instance.

In some embodiments, the intrinsic labels also include non-spatial fields such as condition class, severity, material type, component type, and other scalar or categorical outputs. In some embodiments, the intrinsic labels include a multi-dimensional state tensor or state vector as a ground-truth label, enabling downstream models to predict the full parameterized state from imagery.

In some embodiments, the state tensor serves as the canonical ground-truth representation from which all other intrinsic labels are derived. Spatial annotations (such as segmentation masks and bounding regions), non-spatial labels (such as severity values and categorical classifications), measurement values (such as geometric dimensions and functional property assessments), and other label types derivable from the simulated state may each be computed as projections, functions, or transformations of the state tensor. In this manner, the state tensor provides a unified, high-fidelity label representation from which task-specific label formats may be derived without loss of causal consistency. A downstream model may be trained to predict the full state tensor from imagery, and task-specific outputs may then be decoded from the predicted state tensor.

In some embodiments, the state tensor is a hand-crafted vector with explicitly defined dimensions. In other embodiments, the state tensor is a learned representation produced by an encoding model such as an autoencoder or a variational autoencoder. In certain embodiments, a variational autoencoder compresses a higher-dimensional state description into a dense latent vector, and the latent space of the autoencoder becomes a compact representation of structural state that captures relevant variations while discarding noise. In some embodiments, the choice between hand-crafted and learned state representations is an embodiment choice that depends on the maturity of domain knowledge, the availability of training data for the encoder, and the requirements of the downstream tasks.

In some embodiments, severity is derived from the state tensor rather than independently specified. A severity value may be computed as a function of one or more dimensions of the state tensor, enabling severity labels that are consistent with the underlying simulated state.

In some embodiments, the intrinsic label generator computes visibility fractions and applies an occluded or unknown policy when a condition instance is insufficiently visible in the rendered view (e.g., partially occluded by vegetation or adjacent structures).

In some embodiments, labels are encoded in one or more formats including image-format representations (e.g., multi-channel image files), structured data representations (e.g., JSON, YAML, protocol buffers), coordinate-based representations, or any combination thereof. One skilled in the art will recognize that the choice of label encoding format is an implementation detail and that the intrinsic labeling methods described herein are agnostic to the specific encoding format used.

### G. Optional Composable Refinement and Integrity Verification

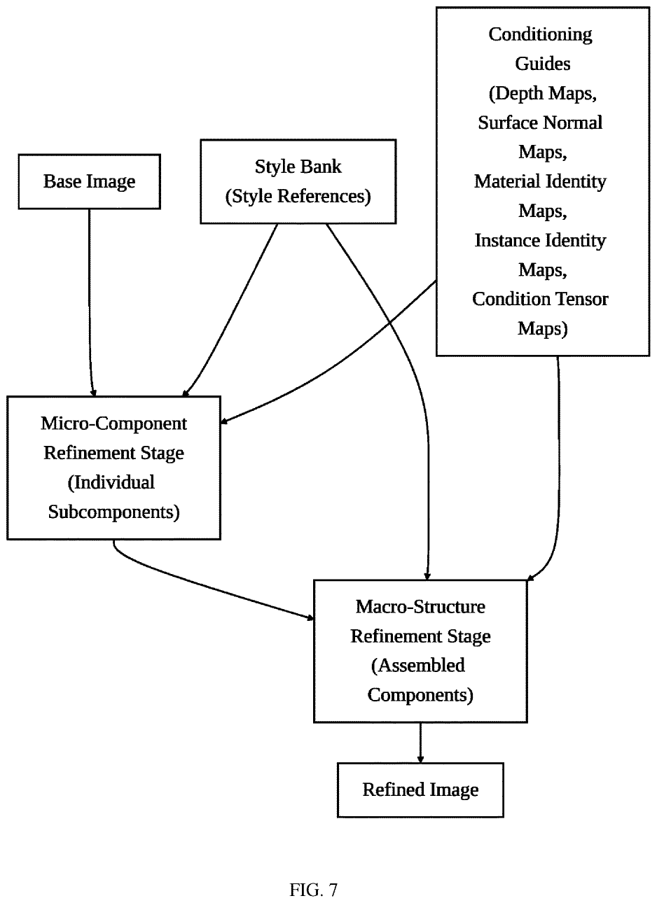

Referring to FIG. 7, the refinement module optionally transforms the base image to produce a refined image. In some embodiments, refinement is composable: a first refinement stage operates at a micro-component level (e.g., refining the appearance of individual shingles, individual fasteners, or individual material patches), and a second refinement stage operates at a macro-structure level (e.g., refining the overall appearance of a roofing system, a building facade, or a full structure). The micro-component and macro-structure refinement stages may be applied independently and in sequence.

In some embodiments, refinement uses one or more style references from a style bank and/or simulator-derived conditioning guides such as depth maps, surface normal maps, instance identity maps, material identity maps, and condition tensor maps.

In some embodiments, the refinement module applies a generative model selected from, without limitation, generative adversarial networks, diffusion models, neural style transfer models, or conditioned image generation models. In some embodiments, the refinement module applies deterministic post-processing transformations in addition to or instead of learned transformations.

In some embodiments, style references are sourced from one or more of: publicly available imagery, laboratory imagery, commercially available imagery, field-captured imagery, and synthetically generated imagery. The style bank is agnostic to the source of style references.

In some embodiments, the micro-component refinement stage applies learned refinement to individual subcomponents independently. For example, in one non-limiting embodiment, a conditional generative model refines the appearance of individual shingles, individual fasteners, or individual material patches by interpolating between a base rendered appearance and a target appearance conditioned on the component's state tensor dimensions. The micro-component refinement stage may use conditioning guides (such as depth maps, normal maps, and instance identity maps aligned to the component) to preserve geometric consistency during refinement. The specific generative model architecture used for micro-component refinement is an embodiment choice; non-limiting examples include conditional diffusion models, generative adversarial networks, and neural style transfer models.

In some embodiments, the macro-structure refinement stage applies learned refinement to the overall appearance of an assembled structural system. Non-limiting examples of macro-level patterns addressed by macro-structure refinement include erosion pathways across a surface (such as water flow wear patterns on a roof), uniform aging effects across a region, geographic or climate-specific aesthetic characteristics, lot-level variation in which different portions of a structure exhibit different aging rates, and other macro-level patterns known to those skilled in the art. In some embodiments, the macro-structure refinement stage modifies the output of the micro-component refinement stage to impose system-level consistency, ensuring that the refined image exhibits realistic macro-level patterns that are consistent with the simulated state tensor at the system level.

In some embodiments, the refinement module uses conditioning guides derived from the renderer and the intrinsic label generator to preserve label integrity during refinement. Non-limiting examples of conditioning guides include depth maps, surface normal maps, instance identity maps, material identity maps, condition tensor maps, and segmentation masks. In some embodiments, the conditioning guides are stored in multi-channel image formats (such as, without limitation, EXR or similar high-dynamic-range formats), structured data formats (such as, without limitation, JSON or protocol buffer representations), or both. The conditioning guides provide the refinement model with geometric and semantic context that constrains the refinement to preserve the spatial correspondence between the refined image and the intrinsic labels.

In some embodiments, the style bank is organized along one or more non-limiting organizational axes, including manufacturer or product line (such as, without limitation, different shingle brands or siding product families), material family, geographic region or climate zone, condition or age state, capture modality, and other organizational axes as appropriate for the application domain. In some embodiments, the style bank includes style references from one or more of: publicly available imagery, laboratory imagery, commercially available imagery, field-captured imagery, and synthetically generated imagery. The style bank is agnostic to the source of style references, and additional style references may be added to the style bank without modifying the refinement pipeline. In certain embodiments, the style bank is indexed to enable efficient retrieval of style references matching a specified combination of organizational axes.

In some embodiments, the refinement module applies a CycleGAN or similar unpaired domain adaptation architecture that adjusts overall appearance without requiring paired training data. In another embodiment, the refinement module applies a conditional diffusion model that generates refined images conditioned on the base render and the conditioning guides. In a further embodiment, the refinement module applies a ControlNet-guided architecture in which a pretrained generative model is steered by conditioning guides to produce refined output that preserves geometric and label correspondence. These architectures are non-limiting examples, and other generative model architectures known to those skilled in the art may be used for refinement.

In some embodiments, the refinement module is configured to produce non-photorealistic output when non-photorealistic rendering serves the downstream task objective. For example, in one embodiment, the refinement module applies a stylization that produces cartoon-like, sketch-like, or otherwise abstracted imagery, among other non-photorealistic styles, to improve the robustness of downstream models to visual domain variation. In another embodiment, the refinement module applies minimal or no photorealistic refinement, using the base rendered image directly when the task objective does not require photorealistic appearance. One skilled in the art will recognize that the target appearance distribution for refinement is a task-specific design choice and that the refinement module is not limited to producing photorealistic output.

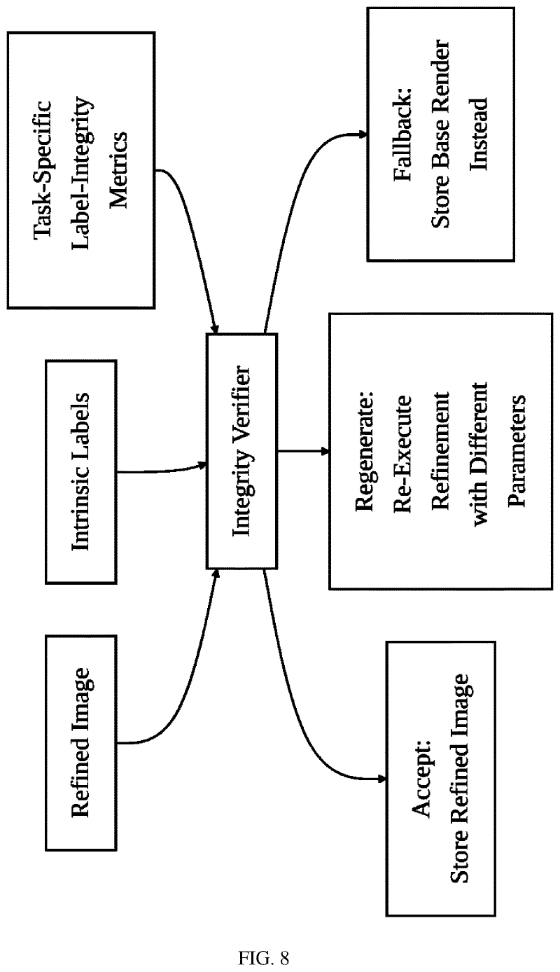

Referring to FIG. 8, the integrity verifier optionally checks whether refinement preserves label semantics. In some embodiments, the system evaluates one or more task-specific label-integrity metrics and triggers one of: an accept decision (the refined image is stored), a regenerate decision (the refinement is re-executed with different parameters), or a fallback decision (the base render is stored instead of the refined image). The label-integrity metrics are task-specific and may be defined differently for different downstream tasks.

### H. Dataset Assembly, Training, and Feedback Loops

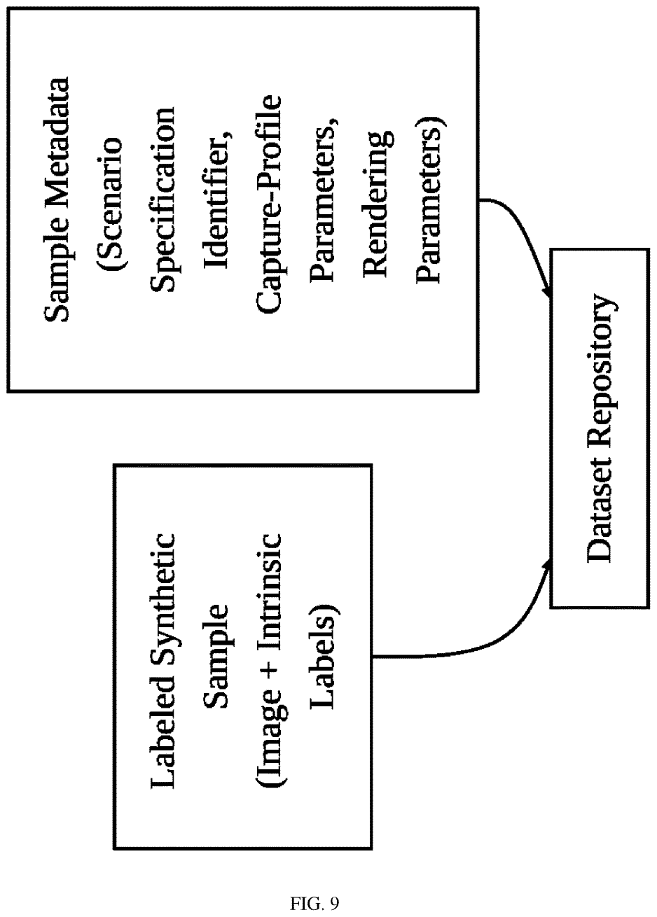

Referring to FIG. 9, the system stores labeled synthetic samples in a dataset repository. In some embodiments, the system also stores sample metadata sufficient for reproducibility and provenance, including at least a scenario specification identifier, capture-profile parameters, and rendering parameters.

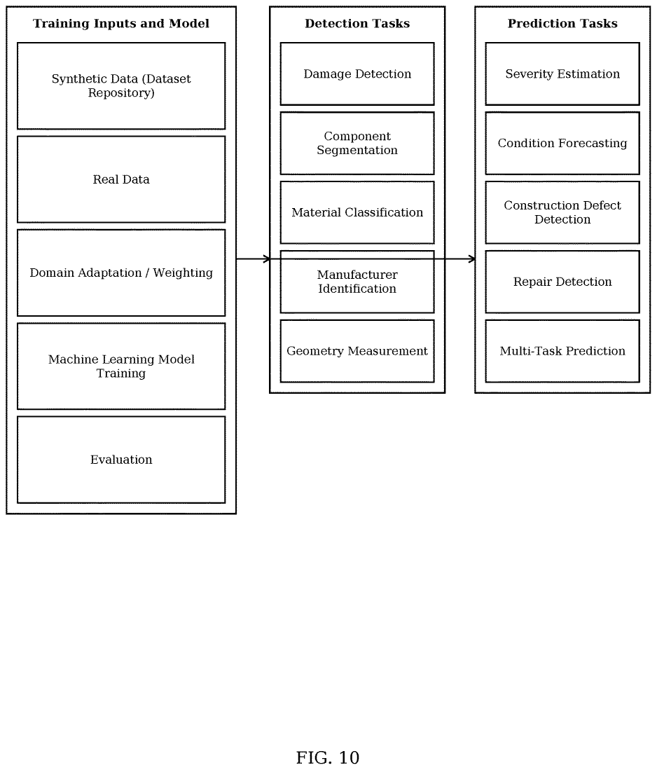

Referring to FIG. 10, the system optionally trains and evaluates one or more machine learning models using the dataset. In some embodiments, the system mixes synthetic data with real data and applies domain adaptation or weighting. In some embodiments, the system trains models for multiple downstream tasks including, without limitation: damage detection, component segmentation, material classification, manufacturer identification, geometry measurement, severity estimation, condition forecasting, construction defect detection, repair detection, and multi-task prediction.

In some embodiments, the system trains a multi-task model that simultaneously predicts at least two outputs such as spatial damage annotations, severity estimates, material classifications, manufacturer identifications, geometry measurements, component classifications, state tensor predictions, and other outputs known to those skilled in the art.

In some embodiments, the system generates training data for manufacturer identification tasks. The construction grammar parameterizes manufacturer-specific visual characteristics (such as, without limitation, distinctive granule patterns, color palettes, profile shapes, and surface textures associated with different manufacturers or product lines), enabling generation of labeled training samples in which the manufacturer identity is an intrinsic label derived from the construction grammar parameters. In some embodiments, manufacturer identification is combined with other downstream tasks in a multi-task prediction framework.

In some embodiments, the system enables counterfactual analysis by generating pairs or sequences of labeled samples that differ only in specified parameters. For example, in one embodiment, the system generates a first sample with a structure in a current state and a second sample with the same structure in a state modified by a proposed intervention (such as a repair, a coating application, or a component replacement), enabling downstream models to learn the visual and functional effects of interventions. In another embodiment, the system generates samples depicting the same structure under different environmental exposure histories, enabling analysis of how different exposure patterns produce different degradation outcomes.

In some embodiments, the system generates training data for geometry measurement tasks. Non-limiting examples of measurable geometric properties include roof pitch angle, plane dimensions, component counts (such as shingle counts, fastener counts, or course counts), valley depths, ridge lengths, eave depths, gutter dimensions, surface area, perimeter measurements, and other dimensional properties derivable from the parameterized model. Because the construction grammar encodes the exact geometric parameters of each component, the intrinsic labels for geometry measurements are derived directly from the grammar specification and are free from measurement error.

In some embodiments, the system generates training data for condition forecasting tasks by applying sequences of perturbation inputs over simulated time steps and producing matched sequences of (state tensor, image, label) tuples. A downstream model trained on such sequences can learn to predict future condition states from a current observation and a perturbation forecast. In one embodiment, the forecasting horizon is configurable and may range from short-term (days to weeks) to long-term (years to decades). In some embodiments, the forecasting training data is conditioned on geographic and climatic parameters, enabling region-specific condition forecasting models.

In some embodiments, the labeled training data enables training of bidirectional models that map from rendered images to state tensor representations (a reverse or inverse mapping) and from state tensor representations to rendered images (the forward mapping). In such embodiments, the system provides supervision for both directions: the forward direction is the rendering pipeline itself, and the reverse direction is supervised by the intrinsic labels that associate each rendered image with its corresponding state tensor. The bidirectional capability enables downstream applications including, without limitation, specification reconstruction from imagery, as-built condition assessment, and generation of synthetic views from inferred state representations.

Non-limiting examples of downstream tasks further include substrate integrity assessment, coating needs assessment, warranty analysis, insulation assessment (when thermal modalities are available), sagging detection, degranulation assessment, text extraction from oblique imagery, property condition assessment, component classification for inventory purposes, material performance inference, recall detection (identifying components subject to manufacturer recalls), autonomous inspection planning (including path planning for drone-based or ground-based inspection platforms), and other tasks known to those skilled in the art. It will be appreciated by those skilled in the art that the intrinsic labeling capability of the disclosed system enables training data generation for any downstream task that can be supervised by information derivable from the parameterized model, the state tensor, or the condition state artifact.

In some embodiments, the system supports a pre-training and fine-tuning paradigm in which a downstream model is first pre-trained on synthetic training data generated by the disclosed system and subsequently fine-tuned on a smaller quantity of real-world imagery with real-world labels. In such embodiments, the synthetically pre-trained model provides a feature-learning foundation that reduces the quantity of real-world data required for fine-tuning to achieve a target performance level. In some embodiments, the synthetic pre-training provides supervision for label types (such as state tensor predictions or multi-dimensional severity vectors) that are impractical to annotate manually in real-world data.

In some embodiments, the system generates multi-resolution training data by rendering at a high resolution and downsampling to one or more lower resolutions while preserving the intrinsic labels. In such embodiments, a downstream model may be trained on matched high-resolution and low-resolution pairs to learn resolution-invariant features. In certain embodiments, the system identifies failure modes that occur specifically at low resolutions (where fine structural details are not visible) and generates targeted additional training data to address those failure modes. In some embodiments, insights about low-resolution failure modes obtained from synthetic data are transferred to improve model performance on real-world low-resolution imagery captured at altitude or with lower-quality sensors.

In some embodiments, the system generates training data with systematic variation across capture conditions to promote downstream model invariance to conditions that are irrelevant to the task objective. For example, in one embodiment, lighting conditions (including sun position, intensity, cloud cover, and atmospheric haze) are varied across the full gamut of plausible and implausible conditions for each structural configuration, so that a downstream model trained on this data learns to be invariant to lighting variation. Similarly, sensor artifacts, atmospheric conditions, capture angles, and other capture parameters may be varied systematically to promote invariance. In certain embodiments, conditions that are relevant to the task objective (such as condition state) are varied independently of conditions that are irrelevant (such as lighting), enabling disentangled training in which the model learns to predict task-relevant properties while ignoring irrelevant capture conditions.

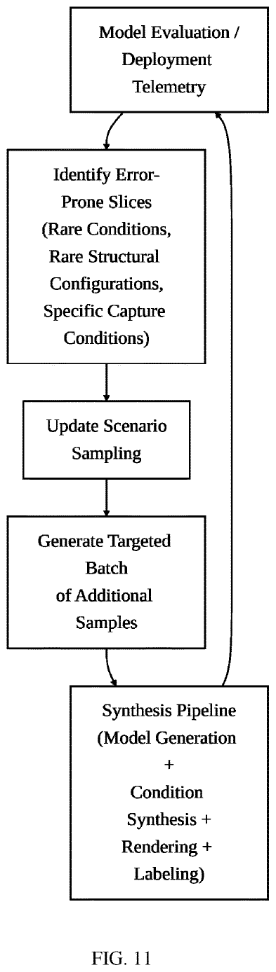

Referring to FIG. 11, the system optionally uses a feedback loop to target additional synthesis. In one embodiment, the feedback loop identifies error-prone slices (e.g., rare conditions, rare structural configurations, specific capture conditions) and updates scenario sampling to generate targeted batches that address identified weaknesses. In some embodiments, feedback is derived from model evaluation metrics; in some embodiments, feedback is derived from deployment telemetry.

### I. Differentiating Characteristics

The disclosed system is distinguishable from several categories of prior approaches. Unlike pure physics-based simulation, which models physical mechanisms at potentially intractable levels of detail, the disclosed system operates at a configurable level of abstraction, modeling outcomes and state transitions without requiring molecular or atomic-level simulation. Unlike digital twin approaches that reconstruct specific real-world structures, the disclosed system generates across a combinatorial space of structural configurations and need not model any specific existing structure. Unlike unconstrained domain randomization, the disclosed system applies causal mappings from perturbation inputs to state changes, ensuring that generated training data encodes causal relationships between perturbation inputs and their structural effects. Unlike correlation-based approaches that layer statistics on top of observational data, the disclosed system generates training data with intrinsic causal structure, enabling downstream models to learn causal mechanisms.

The deterministic linking between construction grammar parameters, visual representations, and label sets ensures that any change to a parameter produces a corresponding and predictable change in the rendered output and in the associated labels. This deterministic linkage supports consistency at scale: the system can generate large volumes of training data (e.g., millions to hundreds of millions of samples) with consistent causal structure across all samples. It will be appreciated by those skilled in the art that these differentiating characteristics are illustrative and that the disclosed systems may provide additional advantages not enumerated herein.

In some embodiments, the disclosed system is further distinguishable from approaches that generate visual content from natural language prompts or other high-level descriptions without maintaining deterministic linkage between generation parameters and output content. Unlike such approaches, in which the relationship between input parameters and output visual elements may be stochastic and non-invertible, the present system maintains traceable correspondence between every construction grammar parameter, every state tensor dimension, and every visual element in the rendered output. This traceable correspondence enables intrinsic labeling: because every visual element traces to a known parameter, the system can compute ground-truth labels without human annotation. It will be appreciated by those skilled in the art that this deterministic linkage is a structural property of the disclosed pipeline architecture rather than a property of any specific rendering engine or generative model.

In some embodiments, the disclosed system operates at an intermediate level of abstraction between intractable physics simulation and unconstrained domain randomization. The system does not attempt to simulate physical mechanisms at molecular or atomic levels of detail, which may be computationally intractable for large-scale dataset generation. Nor does the system randomly vary visual properties without causal structure, which may produce training data that fails to encode meaningful relationships between perturbation inputs and structural effects. Instead, the system models outcomes and state transitions at a configurable level of abstraction, using rule-based, learned, or hybrid transition functions that capture the directional relationships between perturbation inputs and structural effects without requiring complete physical simulation of the underlying mechanisms.

In some embodiments, the labeled training data generated by the disclosed system encodes causal structure linking perturbation inputs to their structural effects, which enables downstream models trained on this data to learn causal mechanisms rather than spurious correlations. In contrast, training data generated by approaches that lack causal structure between generation parameters and output content may produce models that learn correlational patterns present in the training distribution but that do not generalize to novel conditions or support causal reasoning tasks such as condition forecasting or intervention analysis. The causal structure in the disclosed system's training data arises from the deterministic linkage between construction grammar parameters, state transition functions, and rendered output, and is preserved through intrinsic labeling.

### J. Additional Embodiments

In some embodiments, the system extends to additional asset classes beyond building envelopes, using the same core pipeline with asset-class-specific construction grammars, materials, and degradation primitives. Non-limiting additional asset classes include facades, bridge decks, road surfaces, paving, HVAC systems, solar panel arrays, and utility infrastructure.

In some embodiments, the renderer produces multi-modal outputs including RGB imagery, thermal imagery, hyperspectral imagery, and depth imagery, and intrinsic labels are co-registered across modalities.

In some embodiments, the simulated environment is used as a training and evaluation testbed for autonomous inspection systems, including path-planning for drone or ground-based inspection platforms.

In some embodiments, the system generates training data for intervention analysis: given a current state and a proposed repair or modification, the system generates predicted post-intervention states and corresponding imagery and labels.

In some embodiments, the system generates time-series training data by applying sequences of perturbation inputs across simulated time steps, producing matched sequences of (state, image, label) tuples suitable for training temporal models.

In some embodiments, the system generates training data at a scale of at least one million samples, at least ten million samples, or at least one hundred million samples.

In some embodiments, the system provides a privacy advantage in that the synthetic training data need not contain imagery of any specific real-world structure, property, or location. Because the parameterized model generator produces novel structural configurations from construction grammar parameters rather than reconstructing existing real-world structures from sensor data, the resulting training data contains no personally identifiable information, no property-specific identifying characteristics, no location-specific details, and no other information that would identify a specific real-world structure. This characteristic is particularly advantageous for deployments in which privacy regulations restrict the collection, storage, or use of imagery depicting real-world properties.

In some embodiments, the system generates training datasets ranging in scale from thousands of samples to hundreds of millions of samples or more. The scale of generation is configurable and may be selected based on the requirements of the downstream task, the diversity of the structural configuration space, and the available computational resources. In some embodiments, large-scale generation is distributed across multiple computing nodes operating in parallel, with each node generating independent samples from the shared scenario specification and construction grammar.

The system is agnostic to computing platform and may be implemented on a variety of hardware architectures. Non-limiting examples of computing platforms include GPU-accelerated systems, CPU-based systems, cloud-based computing services, on-premises computing clusters, specialized AI accelerators (such as, without limitation, application-specific integrated circuits and tensor processing units), field-programmable gate arrays, and other computing platforms known to those skilled in the art. In some embodiments, different stages of the pipeline execute on different hardware: for example, rendering may execute on GPU-accelerated hardware while condition synthesis executes on CPU-based hardware. The pipeline is not limited to any specific hardware architecture.

In some embodiments, the parameterized model and scene assets are represented in one or more file formats selected based on the rendering engine and pipeline configuration. Non-limiting examples of 3D scene representation formats include Universal Scene Description (USD), native formats of specific rendering engines, Object (OBJ) format, Filmbox (FBX) format, GL Transmission Format (glTF), Computer-Aided Design (CAD) formats, and other scene representation formats known to those skilled in the art. The construction grammar is not coupled to any specific file format, and the system may produce output in any format consumable by the selected rendering engine.

In some embodiments, the system supports one or more generation modes selected based on the deployment context and throughput requirements. Non-limiting examples of generation modes include batch offline generation (in which a large number of samples are generated in advance and stored), on-demand generation (in which individual samples are generated in response to specific requests), streaming generation (in which samples are generated continuously and consumed by a training pipeline in real time), and distributed parallel generation (in which multiple generation instances operate concurrently across a computing cluster). The system is not limited to any specific generation mode, and different generation modes may be used for different stages of a model development lifecycle.

### K. General Implementation Considerations

The various embodiments described herein may be embodied in the form of methods and systems for practicing those methods. The disclosed methods may be performed by a combination of hardware, software, firmware, and computer-readable media installed in and/or communicatively connected to a computing system. Systems, apparatus, and methods described herein may be implemented using one or more computers using well-known computer processors, memory units, storage devices, computer software, and other components. A computer includes a processor for executing instructions and one or more memories for storing instructions and data. A computer may also include, or be coupled to, one or more mass storage devices. The various processes described herein may be implemented as instructions stored on one or more non-transitory computer-readable media, which when executed by one or more processors cause the one or more processors to perform the described operations. Non-transitory computer-readable media include, without limitation, magnetic storage devices, optical storage devices, solid-state storage devices, and any other tangible storage medium capable of storing instructions for execution by a processor. Systems, apparatus, and methods described herein may be implemented within a network-based cloud computing system, on local hardware, on GPU-accelerated systems, on distributed computing clusters, or on any combination thereof.

It should be noted that for clarity of explanation, the illustrative embodiments described herein may be presented as comprising individual functional blocks or combinations of functional blocks. The functions that these blocks represent may be provided through the use of either dedicated or shared hardware, including, but not limited to, hardware capable of executing software. It will be appreciated by those skilled in the art that the block diagrams presented herein (FIGS. 1 through 11) represent conceptual views of illustrative functions, operations, and/or circuitry embodying the principles described herein. Similarly, it will be appreciated that any flowcharts, flow diagrams, state transition diagrams, and the like represent various processes which may be substantially represented in computer-readable medium and so executed by a computer, machine, or processor, whether or not such computer, machine, or processor is explicitly shown. One skilled in the art will recognize that an implementation of an actual computing system may have other structures and may contain other components as well, and that a high-level representation of some of the components of such a system is for illustrative purposes.

The foregoing Detailed Description is to be understood as being in every respect illustrative and exemplary, but not restrictive, and the scope of the present disclosure is not to be determined from the Detailed Description, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the present disclosure. Those skilled in the art could implement various other feature combinations without departing from the scope and spirit of the present disclosure.

What is claimed is:

1. A system for generating labeled synthetic training data, the system comprising:
at least one processor; and
at least one memory storing instructions that, when executed by the at least one processor, cause the system to:
(a) generate a parameterized model of at least one structural component of a structure or built-environment asset, the parameterized model having a set of configurable parameters including at least geometry parameters and material parameters;
(b) apply condition synthesis to the parameterized model by applying at least one perturbation input through a state transition function to produce a condition state artifact identifying one or more condition instances, the condition state artifact comprising at least condition location information, condition type information, and severity information for the one or more condition instances;
(c) render at least one base image of the parameterized model in a simulated condition state under a capture profile using a camera model having associated camera parameters;
(d) compute intrinsic labels by using the camera parameters to align condition information from the condition state artifact to the base image, the intrinsic labels comprising, for each visible condition instance, at least a spatial annotation, whereby the intrinsic labels are derived from simulator state without human annotation; and
(e) store a labeled synthetic sample comprising the base image and the intrinsic labels in a dataset repository.

2. The system of claim 1, wherein generating the parameterized model comprises generating the parameterized model using a composable, parameterized construction grammar that assembles subcomponents into the at least one structural component according to configurable assembly rules, the construction grammar defining parameters that constitute an internal representation of the structural component.

3. The system of claim 1, wherein applying condition synthesis comprises applying a causal mapping from the at least one perturbation input to at least one parameter change of the parameterized model or the condition state artifact, wherein the state transition function is implemented as at least one of: a rule-based mapping, a learned transition function, and a hybrid mapping combining rule-based and learned components.

4. The system of claim 3, wherein the causal mapping supports at least one of: a one-to-many mapping in which a single perturbation input produces changes across multiple parameters, and a many-to-one mapping in which multiple perturbation inputs jointly determine a parameter change.

5. The system of claim 1, wherein applying condition synthesis comprises simulating at least one condition selected from the group consisting of: hail impact, wind-driven uplift, UV aging, missing components, cracking, delamination, corrosion, biological growth, ponding, mechanical impact, construction defects, and repairs.

6. The system of claim 1, wherein the condition state artifact comprises a multi-dimensional state tensor encoding structural state at a component level, and wherein the intrinsic labels further comprise the multi-dimensional state tensor as a ground-truth label.

7. The system of claim 6, wherein the multi-dimensional state tensor is composable, such that component-level state tensors are composed into a system-level state tensor representing the structural state of a multi-component structure.

8. The system of claim 1, wherein rendering comprises varying the capture profile across a distribution comprising at least two of: viewpoint, focal length, altitude, lighting conditions, atmospheric effects, and sensor artifacts.

9. The system of claim 1, wherein the system further emulates characteristics of at least one real-world sensor by simulating at least one of: a focal length range, an altitude range, a ground sampling distance, lens distortion, motion blur, and compression artifacts.

10. The system of claim 1, wherein rendering further produces at least one auxiliary channel selected from the group consisting of: a depth map, a surface normal map, an instance identity map, and a material identity map.

11. The system of claim 1, further comprising refining the base image to produce a refined image using a composable refinement pipeline comprising at least one of: a micro-component refinement stage and a macro-structure refinement stage applied independently.

12. The system of claim 11, further comprising computing one or more task-specific label-integrity metrics comparing the refined image to the intrinsic labels and selecting a decision from the group consisting of accept, regenerate, and fallback.

13. The system of claim 1, wherein applying condition synthesis further comprises enforcing plausibility constraints that restrict or shape an output space based on a task objective associated with generating the labeled synthetic training data, wherein the plausibility constraints are task-specific rather than limited to real-world physical plausibility.

14. The system of claim 1, further comprising training a machine learning model using a training set comprising a plurality of labeled synthetic samples, wherein the machine learning model is trained for at least one downstream task selected from the group consisting of: damage detection, component segmentation, material classification, manufacturer identification, geometry measurement, severity estimation, condition forecasting, construction defect detection, and repair detection.

15. A computer-implemented method for generating labeled synthetic training data, the method comprising:
(a) generating, by at least one processor, a parameterized model of at least one structural component of a structure or built-environment asset, the parameterized model having a set of configurable parameters;
(b) applying, by the at least one processor, condition synthesis to the parameterized model by applying at least one perturbation input through a state transition function to produce a condition state artifact identifying one or more condition instances, the condition state artifact comprising at least condition location information, condition type information, and severity information;
(c) rendering, by the at least one processor, at least one base image of the parameterized model in a simulated condition state under a capture profile using camera parameters;
(d) computing, by the at least one processor, intrinsic labels by using the camera parameters to align condition information from the condition state artifact to the base image, the intrinsic labels comprising at least a spatial annotation for each visible condition instance, the intrinsic labels derived from simulator state without human annotation; and
(e) storing, by the at least one processor, a labeled synthetic sample comprising the base image and the intrinsic labels in a dataset repository.

16. The method of claim 15, further comprising refining the base image to produce a refined image using composable style transfer comprising at least one of: a micro-component refinement stage that refines appearance of individual subcomponents and a macro-structure refinement stage that refines appearance of one or more assembled structural components.

17. The method of claim 15, wherein applying condition synthesis further comprises modeling at least one of a degradation and a repair, such that the state transition function produces at least one of a degraded state and an improved state relative to a prior state.

18. The method of claim 15, further comprising performing scenario sampling to select scenario specifications for generating labeled synthetic samples, and updating the scenario sampling using feedback derived from at least one of model evaluation and deployment telemetry to generate a targeted batch of additional labeled synthetic samples.

19. A non-transitory computer-readable medium storing instructions that, when executed by one or more processors, cause the one or more processors to:
(a) generate a parameterized model of at least one structural component of a structure or built-environment asset, the parameterized model having a set of configurable parameters including at least geometry parameters and material parameters;
(b) apply condition synthesis to the parameterized model by applying at least one perturbation input through a state transition function to produce a condition state artifact identifying one or more condition instances;
(c) render at least one base image of the parameterized model in a simulated condition state under a capture profile using camera parameters;
(d) compute intrinsic labels by using the camera parameters to align condition information from the condition state artifact to the base image, the intrinsic labels comprising at least a spatial annotation for each visible condition instance, the intrinsic labels derived from simulator state without human annotation; and
(e) store a labeled synthetic sample comprising the base image and the intrinsic labels in a dataset repository.

20. The non-transitory computer-readable medium of claim 19, wherein the instructions further cause the one or more processors to generate the parameterized model using a composable, parameterized construction grammar that assembles subcomponents into the at least one structural component according to configurable assembly rules.
